(19) United States
(12) Patent Application Publication
(10) Pub. No.: US 2025/0305979 A1
(43) Pub. Date: Oct. 2, 2025

(54) DEVICE FOR EVALUATING POSITIVE ELECTRODE SLURRY FOR ALL-SOLID-STATE BATTERY

(71) Applicant: HONDA MOTOR CO., LTD., Tokyo (JP)

(72) Inventors: Sayaka Tahara, Wako-shi (JP); Mayuko Ogasawara, Wako-shi (JP); Tsutomu Kameyama, Wako-shi (JP)

(21) Appl. No.: 19/064,928

(22) Filed: Feb. 27, 2025

(30) Foreign Application Priority Data
Mar. 29, 2024 (JP) 2024-058162

(51) Int. Cl. G01N 27/22

(52) U.S. Cl. CPC G01N 27/22

(57) ABSTRACT

To accurately evaluate a coating state of a solid electrolyte in a positive electrode active material in a positive electrode slurry for an all-solid-state battery. A device for evaluating a positive electrode slurry for an all-solid-state battery, including a flow path through which the positive electrode slurry flows and a measurement unit configured to measure an AC impedance of the positive electrode slurry, wherein the measurement unit includes a first channel unit configured to measure the AC impedance at a first predetermined frequency and a second channel unit configured to measure the AC impedance at a second predetermined frequency, and the measurement unit includes an evaluation unit configured to evaluate the quality of the coating state of a solid electrolyte in a positive electrode active material based on an imaginary axis parameter of the AC impedance and a real axis parameter of the AC impedance measured by the first channel unit and the second channel unit.

### CROSS-REFERENCE TO RELATED APPLICATION

Priority is claimed on Japanese Patent Application No. 2024-058162, filed Mar. 29, 2024, the content of which is incorporated herein by reference.

### BACKGROUND OF THE INVENTION

### Field of the Invention

The present invention relates to a device for evaluating a positive electrode slurry for an all-solid-state battery, which accurately evaluates the quality of a positive electrode slurry containing an active material, a solid electrolyte, a conductive additive, a binder material, and the like in a slurry state for all-solid-state batteries.

### Description of Related Art

In the production of electrode slurries used in liquid electrolyte lithium-ion batteries and all-solid-state lithium-ion batteries, generally, the quality of electrode slurries is controlled by rheological evaluation using the viscosity. In addition, as an electrode slurry quality control method, for example, a technology for determining the quality of an electrode slurry by extracting the electrode slurry immediately after production and measuring the AC impedance of the electrode slurry is known. In addition, as a method of evaluating the quality of a positive electrode slurry of an all-solid-state lithium-ion battery, for example, a method of evaluating the coating state of a coating substance in an electrode active material may be exemplified.

Patent Document 1 describes a method of producing a paste containing an active material, a solid electrolyte and a conductive additive, including a measurement step of measuring an AC impedance of the paste corresponding to a predetermined measurement frequency band, a composition ratio determination step of determining whether the composition ratio of the paste is outside a predetermined range based on the width of an arc portion in a real component direction corresponding to a predetermined frequency band in a trajectory of the measured AC impedance on the complex impedance plane, and a removal step of removing the determined paste when the composition ratio is outside the predetermined range.

Patent Document 2 describes that, in a paste evaluation method of evaluating a paste applied to the surface of a battery electrode, using a container having a rotating mechanism and a measurement unit configured to measure an AC impedance of the paste, the measurement unit measures an AC impedance of the paste while rotating the paste contained in the container by the rotating mechanism, the measurement unit has a pair of application electrode plates disposed in parallel to apply an AC voltage to the paste, and the measurement values of the AC impedances for one or more rotations by the rotating mechanism are averaged to correct the measurement error caused by the parallelism error of the pair of application electrode plates.

### PATENT DOCUMENTS

[Patent Document 1] Japanese Unexamined Patent Application, First Publication No. 2015-222651

[Patent Document 2] Japanese Patent No. 5505318

### SUMMARY OF THE INVENTION

Compared to liquid electrolyte lithium-ion batteries, in a positive electrode slurry for an all-solid-state battery, the amount of materials used increases, the slurry contains a composite component of an active material and a solid electrolyte, and the composite (coating state) of the solid electrolyte in the positive electrode active material is said to greatly contribute to battery performance. However, no specific method has been found for evaluating the coating state of the solid electrolyte in the positive electrode active material in a slurry state, and it is difficult to accurately evaluate the coating state.

In order to address the above problems, an object of the present invention is to accurately evaluate a coating state of a solid electrolyte in a positive electrode active material in a positive electrode slurry for an all-solid-state battery, thereby contributing to stabilization of battery performance, improvement of quality control in a production step, and ultimately energy efficiency.

In order to achieve the above object, the present invention provides the following aspects.

[1] A device for evaluating a positive electrode slurry for an all-solid-state battery, which evaluates a coating state of a positive electrode slurry in which at least a positive electrode active material and a solid electrolyte are kneaded and dispersed, the device including:
a flow path through which the positive electrode slurry flows; and
a measurement unit provided at the flow path and configured to measure an AC impedance of the positive electrode slurry,
wherein the measurement unit includes a first channel unit configured to measure the AC impedance at a first predetermined frequency and a second channel unit configured to measure the AC impedance at a second predetermined frequency, and
wherein the measurement unit includes an evaluation unit configured to evaluate the quality of the coating state of the solid electrolyte in the positive electrode active material based on an imaginary axis parameter of the AC impedance and a real axis parameter of the AC impedance measured by the first channel unit and the second channel unit.

When the channel unit is divided into the first channel unit supporting the first predetermined frequency and the second channel unit supporting the second predetermined frequency, and the AC impedance is measured by each channel unit, the measurement time can be shortened compared to when the AC impedance is measured while changing the frequency of the channel unit, the amount of the positive electrode slurry that is a quality determination target can be reduced and erroneous determination can be reduced.

[2] The device for evaluating a positive electrode slurry for an all-solid-state battery according to [1],
wherein the flow path has a first measurement area which is a measurement area of the first channel unit and a second measurement area which is a measurement area of the second channel unit, and
wherein the first measurement area and the second measurement area are partitioned adjacent to each other in a direction in which the flow path extends.

The channel unit is divided into the first channel unit supporting the first predetermined frequency and the second channel unit supporting the second predetermined frequency, a measurement area is provided for each channel unit, a plurality of measurement areas are partitioned adjacent to each other in a direction in which the flow path extends (a direction in which the positive electrode slurry flows), the same slurry is measured using the plurality of channels, and thus the total inspection of the positive electrode slurry can be performed.

[3] The device for evaluating a positive electrode slurry for an all-solid-state battery according to [2],
wherein the measurement unit includes a third channel unit configured to measure the AC impedance at a third predetermined frequency,
wherein the flow path has a third measurement area which is a measurement area of the third channel unit, and
wherein the first measurement area, the second measurement area and the third measurement area are partitioned adjacent to each other in a direction in which the flow path extends.

When the third channel unit supporting the third predetermined frequency is provided in addition to the first channel unit supporting the first predetermined frequency and the second channel unit supporting the second predetermined frequency, it is possible to more accurately measure the AC impedance of the positive electrode slurry.

[4] The device for evaluating a positive electrode slurry for an all-solid-state battery according to any one of [1] to [3],
wherein the first predetermined frequency corresponds to a second arc of a Nyquist diagram drawn based on an imaginary axis parameter of the AC impedance and a real axis parameter of the AC impedance measured by the first channel unit and the second channel unit, and
wherein the second predetermined frequency corresponds to a third arc of the Nyquist diagram drawn based on an imaginary axis parameter of the AC impedance and a real axis parameter of the AC impedance measured by the first channel unit and the second channel unit.

In the Nyquist diagram, by distinguishing between the second arc corresponding to the first predetermined frequency and the third arc corresponding to the second predetermined frequency, it is possible to more accurately analyze information obtained from the AC impedance measurement result of the positive electrode slurry.

[5] The device for evaluating a positive electrode slurry for an all-solid-state battery according to [3],
wherein the third predetermined frequency corresponds to a first arc of a Nyquist diagram drawn based on an imaginary axis parameter of the AC impedance and a real axis parameter of the AC impedance measured by the third channel unit.

In the Nyquist diagram, by distinguishing the first arc corresponding to the third predetermined frequency from the second arc corresponding to the first predetermined frequency and the third arc corresponding to the second predetermined frequency, it is possible to more accurately analyze information obtained from the AC impedance measurement result of the positive electrode slurry.

[6] The device for evaluating a positive electrode slurry for an all-solid-state battery according to [1],
wherein the evaluation unit evaluates the quality of the coating state based on the amount of polarization charge derived from a real component of the AC impedance measured by the first channel unit and an imaginary component of the AC impedance measured by the second channel unit.

The amount of solid content can be estimated from the amount of polarization charge derived from the imaginary component of the AC impedance.

[7] The device for evaluating a positive electrode slurry for an all-solid-state battery according to [1], further including
a control unit that causes the temperature adjusting unit to adjust the temperature of the positive electrode slurry so that the temperature of the positive electrode slurry is within a predetermined range,
wherein the flow path includes a temperature adjusting unit upstream from the measurement unit.

Since the control unit causes the temperature of the positive electrode slurry to be adjusted within a predetermined range, the effect on the AC impedance of a change in the viscosity of the positive electrode slurry caused by temperature change is reduced and it is possible to more accurately analyze information obtained from the AC impedance measurement result of the positive electrode slurry.

According to the present invention, in the positive electrode slurry for an all-solid-state battery, it is possible to accurately evaluate the coating state of the solid electrolyte in the positive electrode active material.

### BRIEF DESCRIPTION OF THE DRAWINGS

FIG. 1 is a schematic view showing a device for evaluating a positive electrode slurry for an all-solid-state battery according to an embodiment of the present invention.

FIG. 2 is a schematic view showing a measurement unit constituting the device for evaluating a positive electrode slurry for an all-solid-state battery according to the embodiment of the present invention.

FIG. 3 is a diagram showing an equivalent circuit formed by the positive electrode slurry.

FIG. 4 is a diagram showing an example of a Nyquist diagram of AC impedance measurement of the positive electrode slurry obtained by the measurement unit of the device for evaluating a positive electrode slurry for an all-solid-state battery according to the embodiment of the present invention.

FIG. 5 shows a Nyquist diagram created based on an imaginary axis parameter (Zim) of the AC impedance and a real component parameter (Zre) of the AC impedance in an example.

FIG. 6 is a diagram showing the relationship between a real component parameter (Zre) of the AC impedance corresponding to a second arc and the solid content of the positive electrode slurry for an all-solid-state battery in an example.

FIG. 7 shows a Nyquist diagram created based on an imaginary axis parameter (Zim) of the AC impedance and a real component parameter (Zre) of the AC impedance in an example.

FIG. 8 is a diagram showing the relationship between an amount of polarization charge (Cp) derived from the imaginary axis parameter (Zim) of the AC impedance corresponding to a third arc and the solid content of the positive electrode slurry for an all-solid-state battery in an example.

### DETAILED DESCRIPTION OF THE INVENTION

Hereinafter, embodiments of the present invention will be described in detail with reference to the drawings.

### Device for Evaluating Positive Electrode Slurry for All-Solid-State Battery

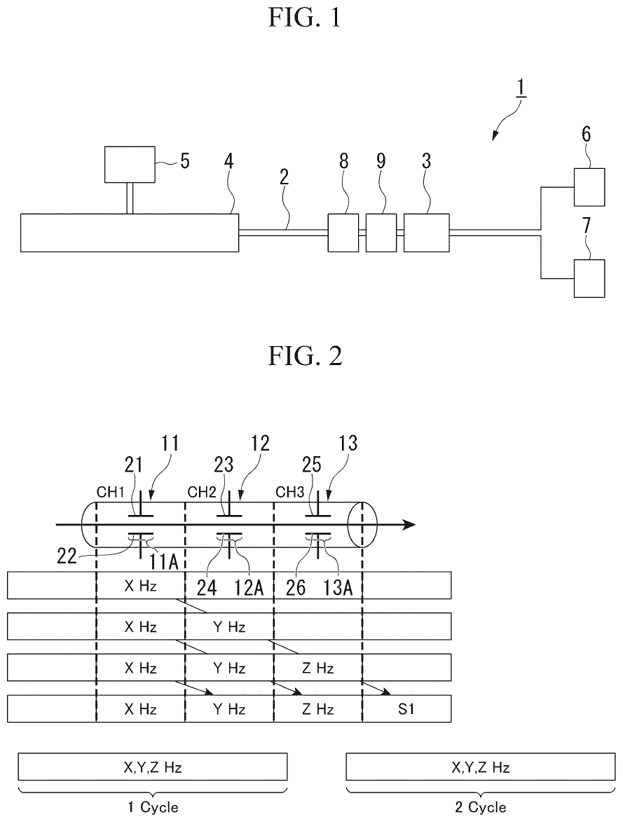

FIG. 1 is a schematic view showing a device for evaluating a positive electrode slurry for an all-solid-state battery according to an embodiment of the present invention. FIG. 2 is a schematic view showing a measurement unit constituting the device for evaluating a positive electrode slurry for an all-solid-state battery according to the embodiment of the present invention. Here, in the drawings used in the following description, in order to facilitate understanding of features, feature parts are enlarged for convenience of illustration in some cases, and dimensional ratios of components are not limited to those shown in the drawings.

As shown in FIG. 1, a device 1 for evaluating a positive electrode slurry for an all-solid-state battery according to the present embodiment (hereinafter sometimes abbreviated as an “evaluation device”) includes a flow path 2, a measurement unit 3, a kneading unit 4, a supply unit 5, a non-defective product collecting unit 6, and a defective product collecting unit 7. In addition, the evaluation device 1 may include a viscosity measurement unit 8 and a temperature adjusting unit 9. The evaluation device 1 is a device for evaluating a coating state (a coating state of a positive electrode active material with a solid electrolyte) of a positive electrode slurry for an all-solid-state battery (hereinafter sometimes abbreviated as a “positive electrode slurry”) in which at least a positive electrode active material and a solid electrolyte are kneaded and dispersed.

The flow path 2 is a flow path through which a positive electrode slurry flows.

The measurement unit 3 is provided at the flow path 2 and measures an AC impedance of the positive electrode slurry that flows through the flow path 2.

As shown in FIG. 2, the measurement unit 3 includes a first channel unit 11, a second channel unit 12, and an evaluation unit. The first channel unit 11 measures the AC impedance of the positive electrode slurry at a first predetermined frequency. The second channel unit 12 measures the AC impedance of the positive electrode slurry at a second predetermined frequency.

The evaluation unit evaluates the quality of the coating state of the solid electrolyte in the positive electrode active material contained in the positive electrode slurry based on an imaginary axis parameter of the AC impedance of the positive electrode slurry and a real axis parameter of the AC impedance of the positive electrode slurry measured by the first channel unit 11 and the second channel unit 12. Specifically, the evaluation unit evaluates the quality of the coating state of the positive electrode slurry based on the amount of polarization charge derived from a real component of the AC impedance of the positive electrode slurry measured by the first channel unit 11 and an imaginary component of the AC impedance of the positive electrode slurry measured by the second channel unit 12.

The flow path 2 has a first measurement area 11A which is a measurement area of the first channel unit 11 and a second measurement area 12A which is a measurement area of the second channel unit 12. The first measurement area 11A and the second measurement area 12A are partitioned adjacent to each other in that order in a direction in which the flow path 2 extends (direction in which the positive electrode slurry flows).

As shown in FIG. 2, the measurement unit 3 preferably includes a third channel unit 13. The third channel unit 13 measures the AC impedance of the positive electrode slurry at a third predetermined frequency.

The evaluation unit preferably evaluates the quality of the coating state of the solid electrolyte of the positive electrode active material contained in the positive electrode slurry based on an imaginary axis parameter of the AC impedance of the positive electrode slurry and a real axis parameter of the AC impedance of the positive electrode slurry measured by the third channel unit 13.

The flow path 2 has a third measurement area 13A which is a measurement area of the third channel unit 13. The first measurement area 11A, the second measurement area 12A and the third measurement area 13A are partitioned adjacent to each other in that order in a direction in which the flow path 2 extends (direction in which the positive electrode slurry flows).

The kneading unit 4 kneads materials for the positive electrode slurry, such as a positive electrode active material, a solid electrolyte, a binder, and a solvent, supplied from the supply unit 5. As the kneading unit 4, for example, a rotation and revolution mixer can be used.

The non-defective product collecting unit 6 collects the positive electrode slurry that has been determined to be non-defective by the evaluation in the measurement unit 3.

The defective product collecting unit 7 collects the positive electrode slurry that has been determined to be defective by the evaluation in the measurement unit 3.

The viscosity measurement unit 8 is provided at the flow path 2 and measures the viscosity of the positive electrode slurry that flows through the flow path 2.

The temperature adjusting unit 9 is provided at the flow path 2 and adjusts the temperature of the positive electrode slurry that flows through the flow path 2.

The evaluation device 1 preferably includes a control unit which causes the temperature adjusting unit 9 to adjust the temperature of the positive electrode slurry so that the temperature of the positive electrode slurry that flows through the flow path 2 is within a predetermined range.

A method of evaluating a positive electrode slurry by the evaluation device 1 of the present embodiment will be described.

The kneading unit 4 kneads materials for the positive electrode slurry, such as a positive electrode active material, a solid electrolyte, a binder, and a solvent, supplied from the supply unit 5 to prepare a positive electrode slurry.

Here, the positive electrode slurry will be described.

The positive electrode slurry contains a positive electrode active material, a solid electrolyte, a conductive additive, and a binder material.

The positive electrode active material is not particularly limited as long as it is a material that can reversibly release and absorb lithium ions and transport electrons, and any known positive electrode active material that can be applied to a positive electrode of an all-solid-state lithium ion battery can be used. Examples thereof include composite oxides such as lithium cobalt oxide (LiCoO₂), lithium nickel oxide (LiNiO₂), lithium manganese oxide (LiMn₂O₄), solid solution oxide (Li₂MnO₃—LiMO₂(M=Co, Ni, etc.)), lithium-manganese-nickel-cobalt oxide (LiNiₓMn_{y}Co_{z}O₂, x+y+z=1), and olivine-type lithium phosphate (LiFePO₄); conductive polymers such as polyaniline and polypyrrole; sulfides such as Li₂S, CuS, Li—Cu—S compounds, TiS₂, FeS, MoS₂, and Li—Mo—S compounds; and mixtures of sulfur and carbon. The positive electrode active material may contain one type of the above materials or two or more thereof.

The solid electrolyte is not particularly limited as long as it has lithium ion conductivity and insulating properties, and a material that is generally used in an all-solid-state lithium ion battery can be used. Examples thereof include inorganic solid electrolytes such as a sulfide solid electrolyte material, an oxide solid electrolyte material, a halide solid electrolyte, and a lithium-containing salt, polymer-based solid electrolytes such as polyethylene oxide, and gel-based solid electrolytes containing a lithium-containing salt or a lithium ion conducting ionic liquid. Among these, the sulfide solid electrolyte material is preferable in consideration of high conductivity of lithium ions and favorable structure formability and interface bonding due to pressing. The form of the solid electrolyte material is not particularly limited, and for example, a particle form may be exemplified.

The positive electrode slurry may contain a conductive additive in order to improve the conductivity of the positive electrode. As the conductive additive, a conductive additive that can be generally used in all-solid-state lithium ion batteries can be used. Examples thereof include carbon materials, for example, carbon black such as acetylene black and ketjen black; carbon fibers; vapor-grown carbon fibers; graphite powders; and carbon nanotubes. The conductive additive may contain one type of the above materials or two or more thereof.

The positive electrode slurry may contain a solvent in order to adjust the viscosity.

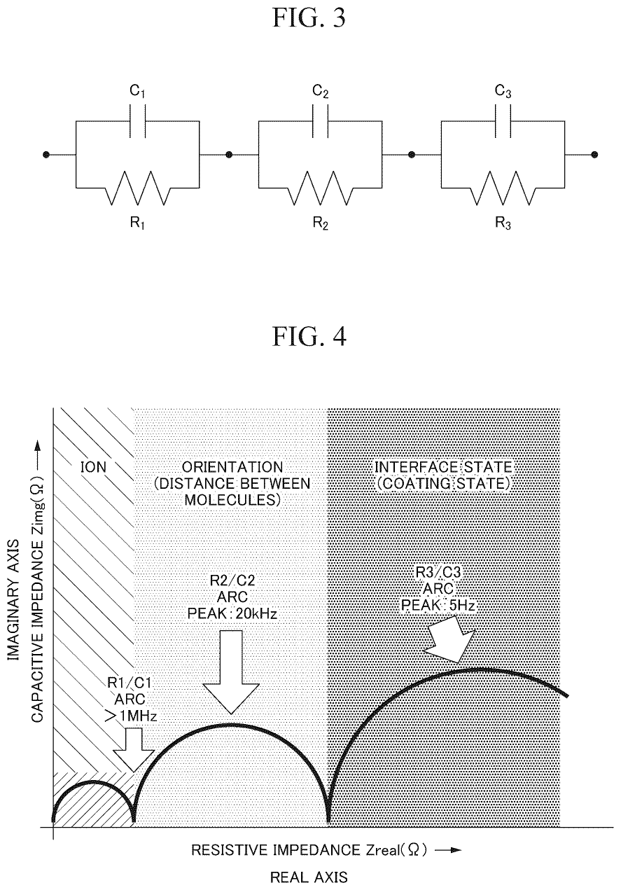

The positive electrode slurry is considered to form an equivalent circuit shown in FIG. 3. In FIG. 3, R1/C1 indicates ion polarization, R2/C2 indicates orientation polarization, and R3/C3 indicates interface polarization.

Here, the equivalent circuit of the positive electrode slurry will be described.

A slurry in which only a positive electrode active material is added to a solvent, a slurry in which a positive electrode active material and a solid electrolyte are added to a solvent, and a slurry in which a binder material is added to a positive electrode active material are prepared, and when the natural frequency of each slurry is measured, a Nyquist diagram as shown in FIG. 4 is obtained. The slurry in which only a positive electrode active material is added has a low natural frequency, the slurry containing a binder has a medium natural frequency, and the slurry containing a solid electrolyte has high natural frequency. Respective frequencies correspond to a first arc, a second arc and a third arc of the Nyquist diagram. Thereby, it is inferred that ion polarization of a mixture of a positive electrode active material, a binder and a solid electrolyte is shown at the measurement frequency of the first arc, which is a high frequency, orientation polarization of a positive electrode active material and a binder is shown at the measurement frequency of the second arc, which is a medium frequency, and interface polarization within the positive electrode active material is shown at the measurement frequency of the third arc, which is a low frequency.

The material of the positive electrode slurry prepared in the kneading unit 4 is sent to the measurement unit 3. The positive electrode slurry sent to the measurement unit 3 is first disposed between two electrodes 21 and 22 provided in the first channel unit 11. The measurement unit 3 applies an AC voltage or an AC current between the two electrodes 21 and 22 and measures the AC impedance of the positive electrode slurry. The first predetermined frequency of the AC voltage or AC current used to measure the AC impedance of the positive electrode slurry in the first channel unit 11 continuously changes, for example, from 1 kHz to 1 MHz. The first predetermined frequency corresponds to the second arc of the Nyquist diagram drawn based on an imaginary axis parameter of the AC impedance of the positive electrode slurry and a real axis parameter of the AC impedance of the positive electrode slurry measured by the first channel unit 11.

Subsequently, the positive electrode slurry is disposed between two electrodes 23 and 24 provided in the second channel unit 12. The measurement unit 3 applies an AC voltage or an AC current between the two electrodes 23 and 24 and measures the AC impedance of the positive electrode slurry. The second predetermined frequency of the AC voltage or AC current used to measure the AC impedance of the positive electrode slurry in the second channel unit 12 continuously changes, for example, from 5 Hz to 1 kHz. The second predetermined frequency corresponds to the third arc of the Nyquist diagram drawn based on an imaginary axis parameter of the AC impedance of the positive electrode slurry and a real axis parameter of the AC impedance of the positive electrode slurry measured by the second channel unit 12.

Subsequently, the positive electrode slurry is disposed between two electrodes 25 and 26 provided in the third channel unit 13. The measurement unit 3 applies an AC voltage or an AC current between the two electrodes 25 and 26 and measures the AC impedance of the positive electrode slurry. The second predetermined frequency of the AC voltage or AC current used to measure the AC impedance of the positive electrode slurry in the third channel unit 13 is, for example, 1 MHz. The third predetermined frequency corresponds to the first arc of the Nyquist diagram drawn based on an imaginary axis parameter of the AC impedance of the positive electrode slurry and a real axis parameter of the AC impedance of the positive electrode slurry measured by the third channel unit 13.

From the measurement data of the AC impedance acquired by the measurement unit 3, an AC frequency range for evaluating the coating state of the solid electrolyte in the positive electrode active material is specified.

In the evaluation device 1 of the present embodiment, among the AC impedance measurement data acquired by the measurement unit 3, an imaginary axis parameter of an AC impedance in a specific frequency range and a real axis parameter of an AC impedance in a specific frequency range can be used to accurately evaluate the coating state of the positive electrode slurry. The first predetermined frequency of the AC voltage or AC current used to measure the AC impedance of the positive electrode slurry in the first channel unit 11 is selected to be, for example, 1 kHz to 1 MHz. The second predetermined frequency of the AC voltage or AC current used to measure the AC impedance of the positive electrode slurry in the second channel unit 12 is selected to be, for example, 5 Hz to 1 kHz. The second predetermined frequency of the AC voltage or AC current used to measure the AC impedance of the positive electrode slurry in the third channel unit 13 is selected to be, for example, 1 MHz.

The imaginary axis parameter of the AC impedance of the positive electrode slurry is preferably an imaginary component (Zim) of the AC impedance or an amount of polarization charge (Cp) derived from the imaginary component (Zim) of the AC impedance. A method of specifying a frequency range of the imaginary component (Zim) or the amount of polarization charge (Cp) for evaluating the coating state of the positive electrode slurry will be described.

In the AC frequency range between 5 Hz and 1 MHz, at a frequency at which the imaginary component (Zim) of the AC impedance or the amount of polarization charge (Cp) derived from the imaginary component (Zim) of the AC impedance changes most significantly according to the type of the positive electrode slurry to be measured, the imaginary component (Zim) or the amount of polarization charge (Cp) is used as the imaginary axis parameter for evaluating the coating state of the positive electrode slurry. The frequency at which the imaginary axis parameter changes significantly varies depending on the substance of the active material and the like, but the frequency at which the imaginary axis parameter changes significantly can be specified, for example, by evaluating a sample in which a load intensity changes when the positive electrode active material is coated with a solid electrolyte.

The real axis parameter of the AC impedance of the positive electrode slurry is preferably the real component (Zre) of the AC impedance of the positive electrode slurry. A method of specifying a frequency range of the real component (Zre) for evaluating the coating state will be described.

The AC impedance data acquired by the measurement unit 3 is displayed (Nyquist plot) on the complex plane by dividing it into the real component (Zre) on the horizontal axis and the imaginary component (Zim) on the vertical axis. FIG. 4 is a diagram showing an example of a Nyquist diagram of AC impedance measurement of the positive electrode slurry obtained by the measurement unit 3. As shown in FIG. 4, theoretically, there are three arc portions in the Nyquist diagram of the positive electrode slurry. In the Nyquist diagram shown in FIG. 4, the third arc corresponds to the second predetermined frequency (5 Hz to 1 kHz). The second arc corresponds to the first predetermined frequency (1 kHz to 1 MHz). The first arc corresponds to the third predetermined frequency (1 MHz).

The evaluation unit of the measurement unit 3 evaluates the quality of the coating state of the solid electrolyte in the positive electrode active material based on the imaginary axis parameter of the AC impedance and the real axis parameter of the AC impedance at the frequency specified by the measurement unit 3 among the AC impedance measurement results of the positive electrode slurry measured by the first channel unit 11 and the second channel unit 12 of the measurement unit 3. In addition, the evaluation unit of the measurement unit 3 preferably evaluates the quality of the coating state of the solid electrolyte in the positive electrode active material based on the imaginary axis parameter of the AC impedance and the real axis parameter of the AC impedance at the frequency specified by the measurement unit 3 among the AC impedance measurement results of the positive electrode slurry measured by the third channel unit 13 of the measurement unit 3.

When the imaginary axis parameter of the AC impedance in the frequency range specified by the measurement unit 3 satisfies a preset reference value based on the AC impedance measurement result of a positive electrode slurry with a favorable coating state of the solid electrolyte in the positive electrode active material (hereinafter referred to as a “non-defective product slurry”) and the real axis parameter of the AC impedance in the frequency range specified by the measurement unit 3 satisfies a preset reference value based on the AC impedance measurement result of the non-defective product slurry, the positive electrode slurry is determined to have a favorable coating state of the solid electrolyte in the positive electrode active material. The reference value is determined from the AC impedance measurement result of the slurry that has been determined to be a non-defective product slurry based on, for example, the battery performance, the dispersion state of the slurry determined using an analysis unit such as a particle size distribution meter, the coating thickness of the solid electrolyte calculated using an analysis unit such as an electron microscope, and the like. An upper limit value and a lower limit value of the reference value are determined depending on the type of the positive electrode slurry.

When the imaginary axis parameter of the AC impedance in the frequency range specified by the measurement unit 3 does not satisfy a preset reference value based on the AC impedance measurement result of the non-defective product slurry or the real axis parameter of the AC impedance in the frequency range specified by the measurement unit 3 does not satisfy a preset reference value based on the AC impedance measurement result of the non-defective product slurry, the positive electrode slurry is determined to have a poor coating state of the solid electrolyte in the positive electrode active material.

According to the device for evaluating a positive electrode slurry for an all-solid-state battery of the present embodiment, the AC impedance of the positive electrode slurry for an all-solid-state battery is measured in a specific frequency range, and based on the imaginary axis parameter of the AC impedance obtained and the real axis parameter of the AC impedance obtained, it is possible to accurately evaluate the coating state of the solid electrolyte in the positive electrode active material.

While the embodiment of the present invention has been described in detail above, the present invention is not limited to the above embodiment, and various modifications and alternations can be made in a range within the spirit and scope of the present invention described in the scope of the claims.

### EXAMPLES

Hereinafter, the present invention will be described in more detail with reference to examples, but the present invention is not limited to the following examples.

### Examples

### “Preparation of Positive Electrode Slurry for All-Solid-State Battery”

A positive electrode slurry for an all-solid-state battery was prepared as shown below.

A binder solution and a conductive additive dispersion were stirred and mixed at 2,000 rpm for 1 minute using a rotation and revolution mixer (kneading device) to obtain a mixture 1.

To the obtained mixture 1, a zirconia ball with a diameter of 2 mm, a positive electrode active material (coated with a solid electrolyte, for example, positive electrode active material: solid electrolyte=75:25 to 90:10 (mass ratio)), and a solvent (butyl butyrate) were added, and the mixture was stirred and mixed at 2,000 rpm for 1 minute to obtain a positive electrode slurry for an all-solid-state battery.

### “AC Impedance Measurement”

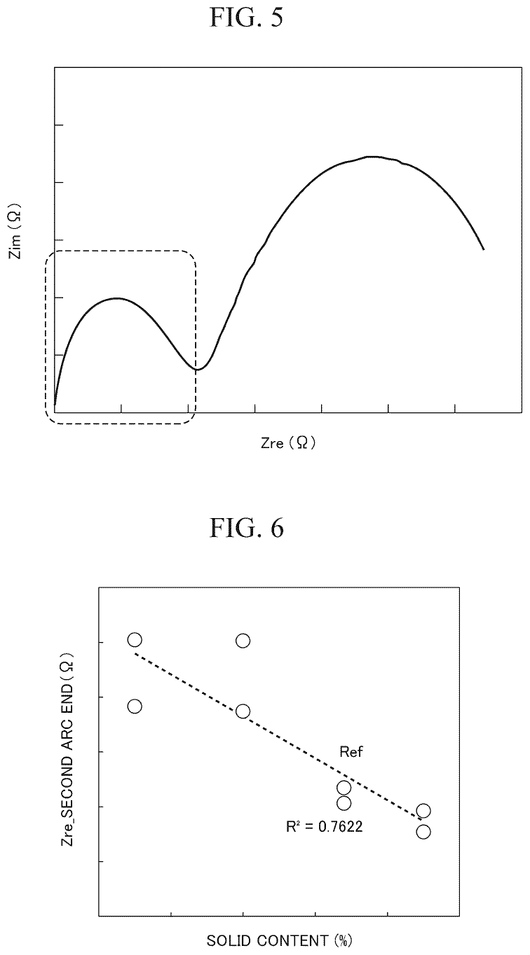

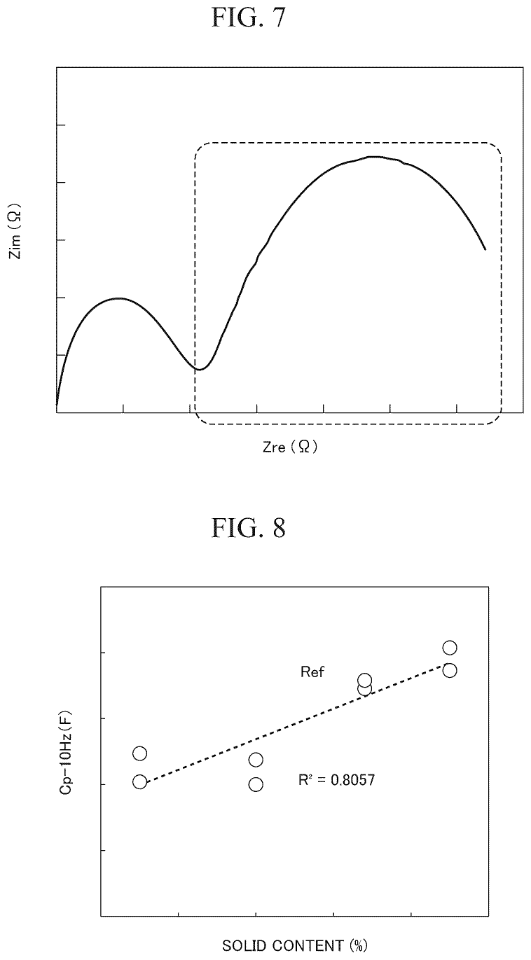

The AC impedance of the positive electrode slurry for an all-solid-state battery was measured, and a Nyquist diagram was created based on the imaginary axis parameter (Zim) of the AC impedance and the real component parameter (Zre) of the AC impedance. The results are shown in FIG. 5 and FIG. 7. The part enclosed by a frame line in FIG. 5 indicates the second arc of the Nyquist diagram. The part enclosed by a frame line in FIG. 7 indicates the third arc of the Nyquist diagram.

In addition, the relationship between the real component parameter (Zre) of the AC impedance corresponding to the second arc and the solid content of the positive electrode slurry for an all-solid-state battery was examined. The results are shown in FIG. 6. Based on the results shown in FIG. 6, it was found that the real component parameter (Zre) of the AC impedance increased as the solid content decreased. This was thought to be because the amount of the solvent between positive electrode active material particles increased as the solid content decreased, and polarization was less likely to occur.

In addition, the amount of polarization charge (Cp) derived from the imaginary axis parameter (Zim) of the AC impedance corresponding to the third arc was calculated, and the relationship between the amount of polarization charge (Cp) and the solid content of the positive electrode slurry for an all-solid-state battery was examined. The results are shown in FIG. 8. Based on the results shown in FIG. 8, this was thought that, as the solid content decreased, the mass of the positive electrode active material in the same volume decreased, and the amount of interface polarization charge decreased.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### EXPLANATION OF REFERENCES

1 Device for evaluating positive electrode slurry for all-solid-state battery
2 Flow path
3 Measurement unit
4 Kneading unit
5 Supply unit
6 Non-defective product collecting unit
7 Defective product collecting unit
8 Viscosity measurement unit
9 Temperature adjusting unit
11 First channel unit
12 Second channel unit
13 Third channel unit

What is claimed is:

1. A device for evaluating a positive electrode slurry for an all-solid-state battery, which evaluates a coating state of a positive electrode slurry in which at least a positive electrode active material and a solid electrolyte are kneaded and dispersed, the device comprising:
a flow path through which the positive electrode slurry flows; and
a measurement unit provided at the flow path and configured to measure an AC impedance of the positive electrode slurry,
wherein the measurement unit includes a first channel unit configured to measure the AC impedance at a first predetermined frequency and a second channel unit configured to measure the AC impedance at a second predetermined frequency, and
wherein the measurement unit includes an evaluation unit configured to evaluate the quality of the coating state of the solid electrolyte in the positive electrode active material based on an imaginary axis parameter of the AC impedance and a real axis parameter of the AC impedance measured by the first channel unit and the second channel unit.

2. The device for evaluating a positive electrode slurry for an all-solid-state battery according to claim 1,
wherein the flow path has a first measurement area which is a measurement area of the first channel unit and a second measurement area which is a measurement area of the second channel unit, and
wherein the first measurement area and the second measurement area are partitioned adjacent to each other in a direction in which the flow path extends.

3. The device for evaluating a positive electrode slurry for an all-solid-state battery according to claim 2,
wherein the measurement unit includes a third channel unit configured to measure the AC impedance at a third predetermined frequency,
wherein the flow path has a third measurement area which is a measurement area of the third channel unit, and
wherein the first measurement area, the second measurement area and the third measurement area are partitioned adjacent to each other in a direction in which the flow path extends.

4. The device for evaluating a positive electrode slurry for an all-solid-state battery according to claims 1,
wherein the first predetermined frequency corresponds to a second arc of a Nyquist diagram drawn based on an imaginary axis parameter of the AC impedance and a real axis parameter of the AC impedance measured by the first channel unit and the second channel unit, and
wherein the second predetermined frequency corresponds to a third arc of the Nyquist diagram drawn based on an imaginary axis parameter of the AC impedance and a real axis parameter of the AC impedance measured by the first channel unit and the second channel unit.

5. The device for evaluating a positive electrode slurry for an all-solid-state battery according to claim 3,
wherein the third predetermined frequency corresponds to a first arc of a Nyquist diagram drawn based on an imaginary axis parameter of the AC impedance and a real axis parameter of the AC impedance measured by the third channel unit.

6. The device for evaluating a positive electrode slurry for an all-solid-state battery according to claim 1,
wherein the evaluation unit evaluates the quality of the coating state based on the amount of polarization charge derived from a real component of the AC impedance measured by the first channel unit and an imaginary component of the AC impedance measured by the second channel unit.

7. The device for evaluating a positive electrode slurry for an all-solid-state battery according to claim 1, further comprising
a control unit that causes the temperature adjusting unit to adjust the temperature of the positive electrode slurry so that the viscosity of the positive electrode slurry in the flow path measured by the viscosity measurement unit is within a predetermined range,
wherein the flow path has a viscosity measurement unit and a temperature adjusting unit upstream from the measurement unit.
